(19) United States
(12) Patent Application Publication
(10) Pub. No.: US 2013/0105073 A1
(43) Pub. Date: May 2, 2013

(54) METHOD OF APPLYING WINDOW FILM

(71) Applicant: Robert J. Reuter, Woodbury, MN (US)

(72) Inventor: Robert J. Reuter, Woodbury, MN (US)

(73) Assignee: 3M INNOVATIVE PROPERTIES COMPANY, ST. PAUL, MN (US)

(21) Appl. No.: 13/807,566

(22) PCT Filed: Jun. 13, 2011
(86) PCT No.: PCT/US2011/040174

§ 371 Date: Dec. 28, 2012

Related U.S. Application Data
(60) Provisional application No. 61/359,634, filed on Jun. 29, 2010.

(51) Int. Cl. B32B 38/00

(52) U.S. Cl. CPC B32B 38/105
USPC 156/267

(57) ABSTRACT

Disclosed herein is a method of applying window film to a window using a cutting tool that allows one to trim the film in a clockwise and/or counterclockwise direction while maintaining an even gap between edges of the film and the frame of the window. The window film may be a solar film, an anti-shattering film, a privacy film, a decorative film, a graphic, a radio frequency blocking film, or a combination thereof.

### FIELD

This disclosure to a method of applying window film to a window comprising a window pane enclosed by a frame.

### BACKGROUND

Window films are generally polymeric films having some amount of transmission to radiation such as visible light. Window films are often applied to a window pane using water to attach and position the film on the pane. Water and any air trapped between the film and the pane is expelled by smoothing a tool with slight pressure across the surface of the film. The film is trimmed such that the edges are close to and even with a frame that encloses the window. Application can be messy and frustrating because water can damage the frame or other nearby objects, and the window film can be difficult to cut accurately and evenly at the edges against the frame. Application can also be costly because a significant amount of window film is often thrown away if the film is accidentally creased or if edges are not cut correctly. Trapped air causes visual distortions and can be difficult to remove without destroying the film. Professional installers are often used to install window films which also adds additional cost.

### SUMMARY

Disclosed herein is a method of applying window film to a window comprising a window pane enclosed by a frame, comprising: contacting a window film to a window pane enclosed by a frame such that the window film completely covers the window pane; smoothing the window film to edges of the window pane such that the film is flush with the window pane and the frame; providing a cutting tool having a blade partially disposed in a housing, the housing having two flat outer surfaces parallel to the blade and offset from the blade by about the same distance, the distance being from about 1/32 to about ¼ inch; and trimming the window film clockwise and/or counterwise by positioning either outer surface against the frame, wherein after trimming, the gap between edges of the window film and the frame is about the same on all sides of the window film.

In some embodiments, the window film comprises a solar film, an anti-shattering film, a privacy film (translucent but not opaque), a decorative film, a graphic, a radio frequency blocking film (prevent use of cell phones), or a combination thereof.

These and other aspects of the invention are described in the detailed description below. In no event should the above summary be construed as a limitation on the claimed subject matter which is defined solely by the claims as set forth herein.

### DETAILED DESCRIPTION OF DRAWINGS

Advantages and features of the invention may be more completely understood by consideration of the following figures in connection with the detailed description provided below. The figures are schematic drawings and illustrations and are not necessarily drawn to scale.

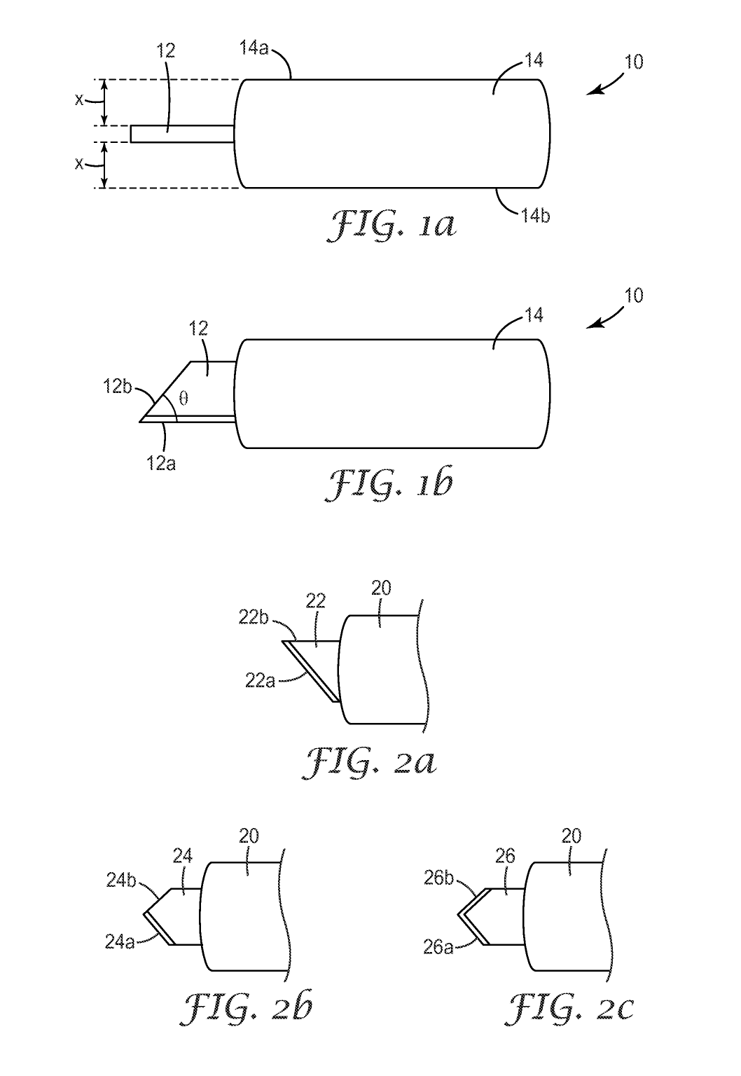

FIG. 1a shows a schematic top down view of an exemplary cutting tool.

FIG. 1b shows a schematic side view of the exemplary cutting tool shown in FIG. 1.

FIGS. 2a-2c show schematic side views of exemplary blade designs.

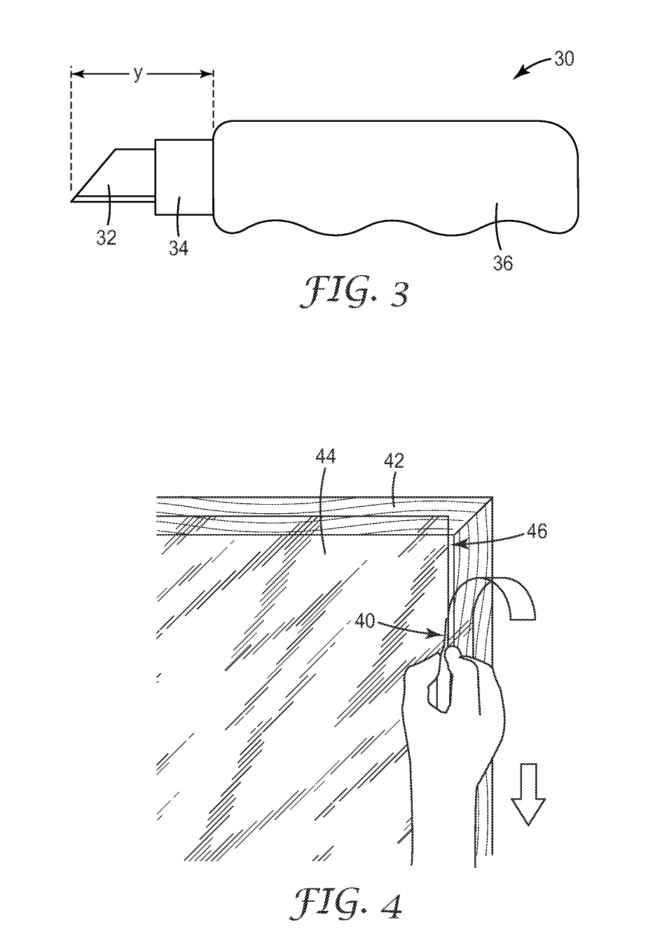

FIG. 3 shows a schematic side view of an exemplary cutting tool.

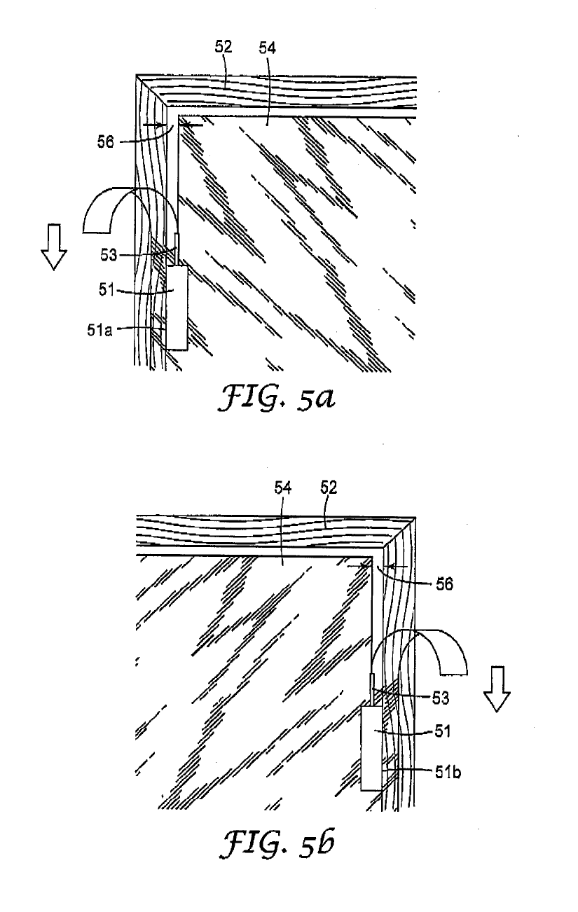

FIGS. 4, 5a and 5b illustrate trimming of the window film.

### DETAILED DESCRIPTION

The present application is related to co-pending and commonly assigned PCT Application No. ______ (Attorney Docket No. 66364WO003), entitled “Method of Applying Window Film”.

Window films are generally thin polymeric films that attach directly to a window pane using adhesive or static. The installation can be very difficult and is often carried out by trained installers with many hours of practice. One method of applying window film to a window pane involves cutting the film to size using measurements of the window pane, followed by applying the film to the pane. This method makes it difficult to obtain accurately cut edges such that an even gap exists between the edges and the frame, especially for odd shaped windows such as windows with arched tops.

Many methods of applying window films include the use of two tools: a spacer tool with a straight edge for holding the film against the pane and providing a straight edge to cut against, and a conventional cutting tool, such as a razor blade or retractable utility knife. Often it is difficult to simultaneously manipulate two tools and obtain smooth, accurately cut edges. Known methods tend to be difficult for the typical user who prefers to cut with his dominant hand because cutting in a single direction, i.e., clockwise or counterclockwise, is awkward. If the user cuts the window film in both directions using a conventional cutting tool such as a retractable utility knife, an even gap between the cut edges and a frame enclosing the pane is difficult to obtain because the blade in a conventional cutting tool is typically supported by an unsymmetrical housing (as described below). The user is unable to position the housing against the frame such that about the same gap in both directions exists between the blade and the frame. Thus, the gap in both directions between the cut edges and the frame will not be even.

Even if a conventional cutting tool has a symmetrical housing for supporting the blade, the housing cannot be used to obtain a suitable gap between the cut edges and the frame. The width of the housing for known cutting tools is such that when the housing is positioned against a frame, the gap between the blade and the frame is too large. The resulting appearance of the covered window pane is not aesthetically pleasing to the observer.

The method disclosed herein can be used to apply window films to windows, with results that are aesthetically pleasing, and with little frustration to the user. The method is amenable for use with most types of window films, for example, those which adhere by static or adhesive, and those which are applied with or without water. The method comprises a cutting tool that is at least partially symmetrical such that the blade is offset equally from the edge of the inside of the frame regardless of the direction in which the tool is used. The cutting tool can be used in place of a spacer tool and a conventional cutting tool such as a utility knife. The user can use the cutting tool to trim window film in either direction, or in both directions, and obtain about the same gap between the edges of the cut film and the frame.

FIG. 1a shows a schematic top down view of the cutting tool used in the method disclosed herein. Cutting tool 10 comprises blade 12 at least partially disposed in housing 14 comprising outer surfaces 14a and 14b which are flat and parallel to the blade. The blade and housing are positioned relative to each other such that distance x, between each side of the blade and its nearest outer surface, is about the same. Distance x may be any suitable length, for example, from about 1/32 to about ¼ inch. Distance x may be about 1/16 inch.

FIG. 1b shows a schematic side view of cutting tool 10. Generally, the blade comprises a cutting edge and an adjacent edge which is adjacent the cutting edge. For exemplary cutting tool 10, blade 12 comprises cutting edge 12a and adjacent edge 12b. Angle θ is the angle formed between the cutting edge and the adjacent edge. The blade may be beveled, meaning θ is less than 90°. A beveled blade is easier to insert into corners when the window film is being trimmed. The blade is typically made of metal, and the cutting edge is sharp enough to cut window film.

FIG. 2 shows schematic side views of exemplary blade designs. Blades 22, 24 and 26 are each disposed in housing 20. The cutting edges are 22a, 24a and 26a, respectively, and the adjacent edges are 22b, 24b and 26b, respectively. The adjacent edge may be a cutting edge, as shown for 26b. Angle θ may be an acute angle, for example, from about 30 to about 80°, or from about 40 to about 70°.

The housing of the cutting tool may have any suitable shape or combination of shapes, as long as the two outer surfaces are each offset from the blade by about the same distance. The housing may be attached to any other component, for example, a grip or handle. FIG. 3 shows a schematic side view of exemplary cutting tool 30 comprising blade 32 at least partially disposed in housing 34, and grip 36 is attached to housing 34. FIG. 3 also shows distance y defined as the length of the housing to the tip of the blade. Generally, y needs to be greater than the height of the frame when measured from the surface of the window pane, so that any part of the cutting tool beyond the housing does not interfere with the gap formed by positioning the tool in either direction against the frame. For example, if a frame extends ½ inch out from the surface of the window pane, then y must be greater than ½ inch.

The housing may support the blade using any suitable means such as mating notches, slots, etc. The housing may be made of metal or polymer, or some combination thereof. The housing may comprise single or multiple parts.

The method disclosed herein comprises a step in which the window film is contacted with a window pane enclosed by a frame. The window film is pre-cut to have an area larger than that of the window pane. For example, the pre-cut window film can have an area such that it extends at least 2 inches beyond each edge of the window pane to be covered. Generally, the term “window pane” refers to that part of the window pane which is visible, i.e., window pane does not include that part of the window pane which is underneath or inserted into a window frame. The window film has an area larger than that of the window pane so that the film completely covers the window pane and overlaps the frame.

The window film is then smoothed onto the window pane so that the film is flush with the pane and the frame. A user may carry out this step by hand or with a smoothing tool having a flat edge. FIG. 4 shows an illustration of a next step in which cutting tool 40 is positioned against frame 42 so that window film 44 is trimmed by moving the tool either clockwise and/or counterclockwise, After trimming, gap 46 between edges of window film 44 and frame 42 is about the same on all sides of the window film.

The method disclosed wherein is also exemplified by comparing FIGS. 5a and 5b. In these figures, the left and right outer surfaces, 51a and 51b, respectively, of housing 51 are positioned against frame 52, such that blade 53 is offset from frame 52 by about the same distance. In FIG. 5a, trimming of window film 54 is carried out counterclockwise, and in FIG. 5b, the direction of trimming is clockwise. Gap 56 formed between the cut edges of window film 54 and frame 52 is about the same when the film is trimmed in either direction.

The method disclosed herein can be used to apply many different types of window films to windows. Window films are designed to deliver a wide range of optical and/or mechanical properties. The window film may comprise a solar film that minimizes the amount of heat entering a building through sunlight, thereby decreasing the amount of energy needed to cool the building. The window film may comprise a solar film that reflects a desired amount of ultraviolet and/or infrared radiation while allowing passage of visible light thereby decreasing the amount of energy needed to cool the building as well as minimizing harm to fabrics, furniture, etc. The window film may comprise an anti-shattering film, or security film, used to prevent glass from shattering. The window film may comprise a privacy film that transmits visible light but which obscures view. The window film may comprise a radio frequency blocking film for preventing or minimizing usage of cell phones, etc. The window film may comprise a decorative film such as a simulated prism film or a frosted film. The window film may be colored and/or provide an image such as a graphic.

The window film may be optically clear, having: high light transmittance of from about 80 to about 100%, from about 90 to about 100%, or from about 95 to about 100% over at least a portion of the visible light spectrum (about 400 to about 700 nm); and a haze value of less than about 5%, or less than about 1%. Haze values in transmission can be determined using a haze meter according to ASTM D1003. The window film may be translucent in that it reflects and transmits light.

The window film layer typically comprises a polymeric film having one or more polymeric layers. Exemplary polymeric films include polyester films, polyacrylate films, cellulose-based films, etc. The polymeric film may comprise a multilayer optical film having from about 10 to about 10,000 alternating layers of first and second polymer layers wherein the polymer layers comprise polyesters. Exemplary multilayer optical films are described in WO 2010/005655 (Sherman et al.) and references cited therein. The multilayer optical film may comprise a specular reflector available from 3M™ Company, for example, 3M™ High Intensity Grade Reflective Products such as High Reflective Visible Mirror Film and High Transmission Mirror Film, and Vikuiti™ films such as Vikuiti™ Enhanced Specular Reflector.

The window film may comprise an adhesive layer on one side of the film, for attaching the film to the window pane. Exemplary adhesive layers are described in US Ser. No. 61/359630 (Reuter et al.; Attorney Docket No. 66364US002 filed on Jun. 29, 2010).

What is claimed is:

1. A method of applying window film to a window comprising a window pane enclosed by a frame, comprising:
contacting a window film to a window pane enclosed by a frame such that the window film completely covers the window pane;
smoothing the window film to edges of the window pane such that the film is flush with the window pane and the frame;
providing a cutting tool having a blade partially disposed in a housing, the housing having two flat outer surfaces parallel to the blade and offset from the blade by about the same distance, the distance being from about 1/32 to about ¼ inch; and
trimming the window film clockwise and/or counterwise by positioning either outer surface against the frame, wherein after trimming, the gap between edges of the window film and the frame is about the same on all sides of the window film.

2. The method of claim 1, wherein the tip of the blade is beveled.

3. The method of claim 1, wherein the film comprises a solar film, an anti-shattering film, a privacy film, a decorative film, a graphic, a radio frequency blocking film, or a combination thereof.
